(19) United States
(12) Patent Application Publication
(10) Pub. No.: US 2010/0241518 A1
(43) Pub. Date: Sep. 23, 2010

(54) TRANSACTION AUTOMATION AND CLIENT-SIDE CAPTURE OF FORM SCHEMA INFORMATION

(76) Inventor: Daniel McCann, Regina (CA)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/522,342

(22) PCT Filed: Jan. 8, 2008
(86) PCT No.: PCT/CA08/00028

§ 371 Date: Apr. 29, 2010

(30) Foreign Application Priority Data
Jan. 8, 2007 (CA) 2,573,516

(51) Int. Cl. G06Q 30/00; G06Q 20/00; G06Q 10/00; G06F 17/00

(52) U.S. Cl. 705/17; 705/27; 705/30; 235/380; 715/224; 715/234

(57) ABSTRACT

A method and apparatus that allows a computer system to automatically navigate through a plurality of webpages is provided. A plurality of webpage objects are provided with each webpage object corresponding to a webpage having at least one input. Each webpage object has form completion data providing instructions how to successfully provide the inputs requested by the corresponding webpage and navigation action data indicating an action to be taken to navigate to a next webpage in the transaction series. In operation, a webpage is checked against the plurality of webpage objects and if the webpage corresponds to one of the webpage objects, the form completion data contained in the webpage object is used to properly provide the requested inputs on the webpage. Once the necessary inputs have been provided, the navigation action data is used to navigate

This invention is in the field of uniform interfaces for automating the submission of information through a series of webpages in a transaction sequence.

### BACKGROUND

Many people now use the Internet to shop online. A user navigates to an online shopping website and can browse items for sale using a web browser. When the user finds an item he or she would like to purchase, they identify the item to the website, (typically by adding to their “virtual shopping cart”) and when they are ready to purchase it they go through a transaction sequence in order to finalize the sale. This transaction sequence is commonly a series of web pages where the user is prompted for information the seller needs in order to complete the sale. At each step (web page) in the transaction sequence, a user is prompted for specific information, which the user must enter in the input fields provided on the web page and then the user must submit the information in one of a number of different ways (clicking a next, a submit button, etc.) in order to move on to the next web page in the transaction sequence. To complete the transaction sequence successfully, the user provides the requested information and navigates through the series of web pages until the sale is made and the owner of the website prepares to ship the purchased articles to the user.

Much of the information requested by a website during a transaction sequence will be the same between most if not all online shopping websites. For example, for most if not all transaction sequences on any number of online shopping websites, the website requests a name of the user, shipping address, billing information, etc. While many of these websites request the same information from a user, each website is free to request this information in any order they would like and the steps and web pages that must be navigated for a successful transaction can be as varied as the websites themselves. There is no standard or uniform way to implement a transaction sequence for a website that all online shopping websites use but transactions sequences will vary from website to website.

Websites can vary on what information is asked for in what stages of a transaction sequence and also by the text label the website assigns to requested information. For example, one website may ask for a shipping address on a web page early in the transaction sequence, while another website may leave it to a web page near the very end of the transaction sequence. Additionally, websites might vary in the labels they assign input. What a website labels an input of information is completely up to the programmers of the website and often information will be called by different names by different websites. For example, one website might label the first name of a user as FIRST_NAME, while another might label it CUSTOMER_FNAME. Each website is free to establish their own proprietary system for requesting information from a user as part of a transaction sequence. Websites do not have to ask for the necessary information to complete a sale or transaction in a uniform manner, but can do it in almost any sequence or way.

Users or other programs interacting with web sites will not be presented with the same sequence of requests for information from different web sites and transaction sequences might be very different from website to website. While this may be an inconvenience for a user, sometimes making it hard for a user to navigate through transactions sequences on different websites, it makes it incredibly hard for other programs that are unable to asses the information being prompted for and supply their own. When a user is manually navigating through the web pages in a transaction sequence, with each page in the transaction sequence prompting the user for the information it requires at that stage and then having the user enter the information entered in the provided fields, it may be inconvenient and confusing but it is not overly difficult for a user to use the textual identification of the various input fields to determine what information should be entered on a webpage and where. However, this becomes a real problem when trying to automate the sequence transaction so that it is done with either minimal or no user input. While a user navigating through numerous different series of webpages to complete a transaction with different information requested in different orders on different websites, may not seem complex, for a computer, this is not a simple operation.

There are prior programs that allow the automatic completion of forms on a specific webpage. However, they require a user to first navigate to the webpage and then to manually submit the webpage or navigate to the webpage. The information requested in the form is then mapped to information known by the program and the necessary information inserted in the correct forms. While these provide some automation, they merely allow the inputting of information on a specific webpage, they do not allow a whole transaction sequence consisting of a series of webpages to be fully automated on a number of different websites. A user still sees the original webpage and must manually navigate through the transaction sequence itself.

### SUMMARY OF THE INVENTION

In a first aspect, a method of navigating a transaction series comprising a plurality of webpages is provided. A plurality of webpage objects are provided. Each webpage object corresponds to a webpage with the webpage defining an electronic form having at least one input and each webpage object having form completion data providing instructions to successfully complete the electronic form defined by the corresponding webpage by providing proper input to the at least one input and navigation action data indicating an action to be taken to navigate to a next webpage in the transaction series. A webpage is checked against the plurality of webpage objects and if the accessed webpage corresponds to one of the webpage objects, then using the instructions in the webpage object to complete the electronic form defined by the webpage by providing the at least one input, and in response to the electronic form being completed, invoking the action indicated by the navigation action data to navigate to the next webpage in the transaction sequence.

In a second aspect, a memory for storing data for access by an application program being executed on a data processing system is provided. The memory has a data structure stored in said memory, said data structure including information resident in a database used by said application program to enable said application to navigate and complete a transaction series comprising a plurality of webpages. The data structure including: a plurality of webpage objects, each webpage object referencing a webpage defining an electronic form having at least one input, each webpage object containing: identifier data identifying the referenced webpage, the webpage being one of the plurality of webpages in the transaction series; form completion data providing the application program with instructions enabling the application program to provide a proper input to the at least one input and successfully complete the electronic form defined by the webpage; and navigation action data indicating an action to be taken by the application program that will cause the application program to navigate to a next webpage in the transaction series.

In a third aspect, a data processing system for navigating a transaction series comprising a plurality of webpages is provided. The data processing system comprises: at least one processor; a memory operatively coupled to the at least one processor; a display device operative to display data; a network interface operably connecting the data processing system to the internet; and a program module stored in the memory and operative for providing instructions to the at least one processor, the at least one processor responsive to the instructions of the program module. The program module is operative for: accessing a webpage; accessing a database containing a plurality of webpage objects, each webpage object corresponding to a webpage, the webpage defining an electronic form having at least one input, each webpage object having: form completion data providing instructions to enable the data processing system to successfully complete the electronic form defined by the corresponding webpage by instructing the data processing system how to provide proper input for the at least one input; and navigation action data indicating an action to be taken to navigate to a next webpage in the transaction series, checking the accessed webpage against the plurality of webpage objects; if the accessed webpage corresponds to one of the webpage objects, then using the instructions in the webpage object to complete the electronic form defined by the webpage by providing the at least one input, and in response to the electronic form being completed, invoking the action indicated by the navigation action data to navigate to the next webpage in the transaction sequence.

In a fourth aspect, a system for navigating a transaction series comprising a plurality of webpages is provided. The system comprises a card reader operative to read data from a card and a data processing system, operatively coupled to the card reader and operative to receive data from the card reader. The data processing system has: at least one processing unit; a display device operative to display data; at least one memory storage device operatively coupled to the processing unit; a network interface operative to connect the data processing system to the internet; and a program module stored in the at least one memory storage device operative for providing instructions to the at least one processing unit, the at least one processing unit responsive to the instructions of the program module. The program module is operative for: accessing a webpage; accessing a database containing a plurality of webpage objects, each webpage object corresponding to a webpage, the webpage defining an electronic form having at least one input, each webpage object having: form completion data providing instructions to enable the data processing unit to successfully complete the electronic form defined by the corresponding webpage by instructing the data process system how to provide proper input for the at least one input; and navigation action data indicating an action to be taken to navigate to a next webpage in the transaction series, checking the accessed webpage against the plurality of webpage objects; if the accessed webpage corresponds to one of the webpage objects, then using the instructions in the webpage object to complete the electronic form defined by the webpage by providing the at least one input, if the instructions include an indication that one of the at least one input of the accessed webpage requires payment information available on identification cards, notifying a user to swipe an identification card in the card reader, obtaining the payment information from the card reader and providing the payment information for the corresponding inputs; and in response to the electronic form being completed, invoking the action indicated by the navigation action data to navigate to the next webpage in the transaction sequence. The card reader is operative for reading information from an identification card and passing the read information to the data processing system.

In one aspect, a method and apparatus for providing a uniform interface to a website in order to perform a transaction sequence over a series of webpages is provided. A database containing a plurality of webpage objects is provided where each webpage object corresponds to a webpage in a transaction series on a website.

To fully or partially automate a transaction sequence, an interface application operates in conjunction with a web browser. As a user views a webpage that is the start of a transaction sequence on a website, the interface application matches the webpage to a located webpage object in the database corresponding to the webpage. The webpage could be matched to the web object using the URL address, however, in some cases this will not be enough to make a correct match. In some cases, the webpage needs to be matched to the webpage object using other identifier information in addition to the URL address or even instead of the URL address to get an accurate match. Once the webpage object corresponding to the webpage is located, it is used by the interface application to complete the necessary input requests on the webpage. These input requests could be for information to be inputted into fields on the webpage, selection of an item from a list (such as a drop down box), selection of a button, selection of a checkbox, etc. Once the input requests on the webpage have been provided with input, the page object is used to determine how to navigate to the next step in the transaction sequence and this next step (webpage) in the transaction sequence is navigated to. In this manner, the interface application keeps matching page objects to each web page it encounters and navigating through a series of webpages in the transaction sequence until the transaction sequence has been successfully completed.

The interface application can be used to fully automate the transaction sequence or it can be used to provide a uniform interface between the webpage and either a user or another application program.

The database of page objects can be populated manually, by passively monitoring a user as he or she manually completes a transaction sequence on a website or by dynamically creating the page objects using an intelligent agent.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is schematic illustration of a data processing system;

FIG. 2 is a schematic illustration of a program module in a memory storage device of the data processing system of FIG. 1 containing a web browser application and an interface application;

FIG. 3A is a schematic illustration of a network configuration in accordance with the present invention;

FIG. 3B is a schematic illustration of a network configuration with a central user database in accordance with another aspect of the present invention;

FIG. 4 is a schematic illustration of a data structure of a page object;

FIG. 5 is a state diagram of an interface application as it navigates through a transaction sequence;

FIG. 6 is a schematic illustration of a program module in a memory storage device of the data processing system of FIG. 1 containing a web browser application, an interface application and an overlaying application;

FIG. 7 is a schematic illustration of another aspect of a network configuration comprising a card reader operatively connected to a data processing system;

FIG. 8 is a flowchart of a method for populating a database with page objects by passively monitoring a user manually completing a transaction sequence; and

FIG. 9 is a flowchart of a method for dynamically populating a database with page objects.

### DETAILED DESCRIPTION OF THE ILLUSTRATED EMBODIMENTS

FIG. 100 illustrates a data processing system 100 suitable for supporting the operation of methods in accordance with the present invention. The data processing system 100 typically comprises: at least one processing unit 103; a memory storage device 104; at least one input device 105; a display device 106 and a program module 108.

The processing unit 103 can be any processor that is typically known in the art with the capacity to run the program and is operatively coupled to the memory storage device 4 through a system bus. In some circumstances the data processing system 100 may contain more than one processing unit 103. The memory storage device 104 is operative to store data and can be any storage device that is known in the art, such as a local hard-disk, etc. and can include local memory employed during actual execution of the program code, bulk storage, and cache memories for providing temporary storage. Additionally, the memory storage device 104 can be a database that is external to the data processing system 100 but operatively coupled to the data processing system 100.

The input device 105 can be any suitable device suitable for inputting data into the data processing system 100, such as a keyboard, mouse or data port such as a network connection and is operatively coupled to the processing unit 103 and operative to allow the processing unit 103 to receive information from the input device 105. The display device 106 is a CRT, LCD monitor, etc. operatively coupled to the data processing system 100 and operative to display information. The display device 106 could be a stand-alone screen or if the data processing system 100 is a mobile device, such as a laptop, the display device 106 could be integrated into a casing containing the processing unit 103 and the memory storage device 104.

The program module 108 is stored in the memory storage device 104 and operative to provide instructions to processing unit 103 and the processing unit 103 is responsive to the instructions from the program module 108.

Although other internal components of the data processing system 100 are not illustrated, it will be understood by those of ordinary skill in the art that only the components of the data processing system 100 necessary for an understanding of the present invention are illustrated and that many more components and interconnections between them are well known and can be used.

Furthermore, the invention can take the form of a computer readable medium having recorded thereon statements and instructions for execution by a data processing system 1. For the purposes of this description, a computer readable medium can be any apparatus that can contain, store, communicate, propagate, or transport the program for use by or in connection with the instruction execution system, apparatus, or device.

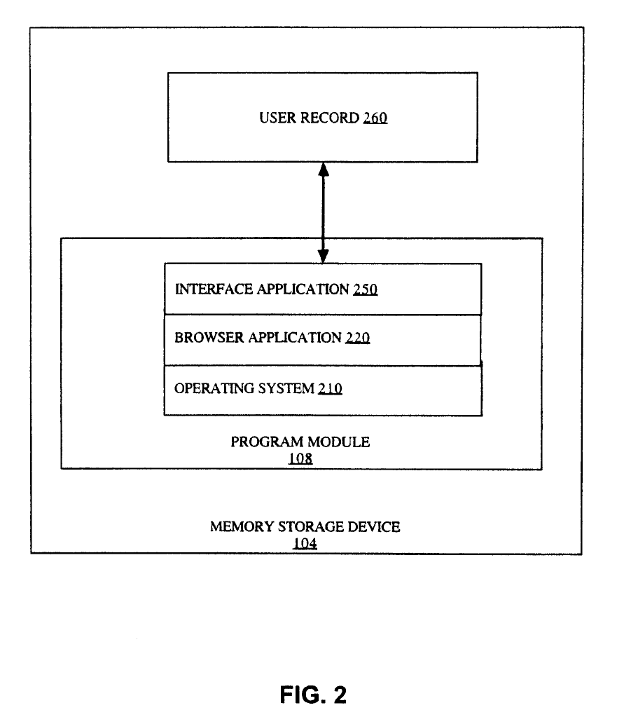

FIG. 2 illustrates a schematic illustration of a program module 108 in a memory storage device 104 of the data processing system 100. The data processing system 100 is operative to implement and run a browser application 220 over top of an operating system 210 and an interface application 250 runs over top of and in conjunction with the browser program 210. The browser application 220 could be any known in the art, such as Microsoft's Internet Explorer™, Mozilla Firefox™, Apple Safari™, Netscape Navigator™ or Opera™.

The interface application 250 has access to a user record 260 containing information related to a particular user such as a name of the user, a shipping address, preferences, etc. The user record 260 is shown in FIG. 2 as being located on the memory storage device 104, but a person skilled in the art will understand that it can be located in another memory storage device operably connected to the data processing system 100.

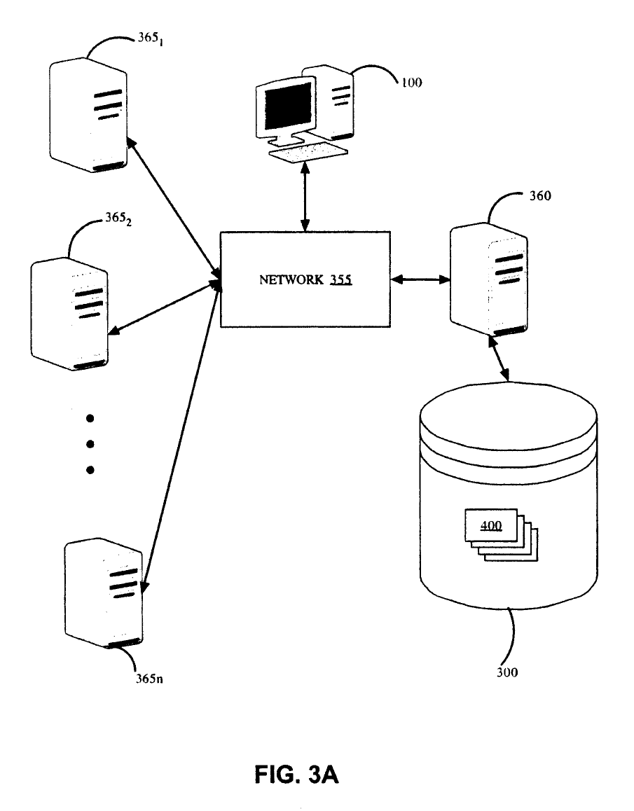

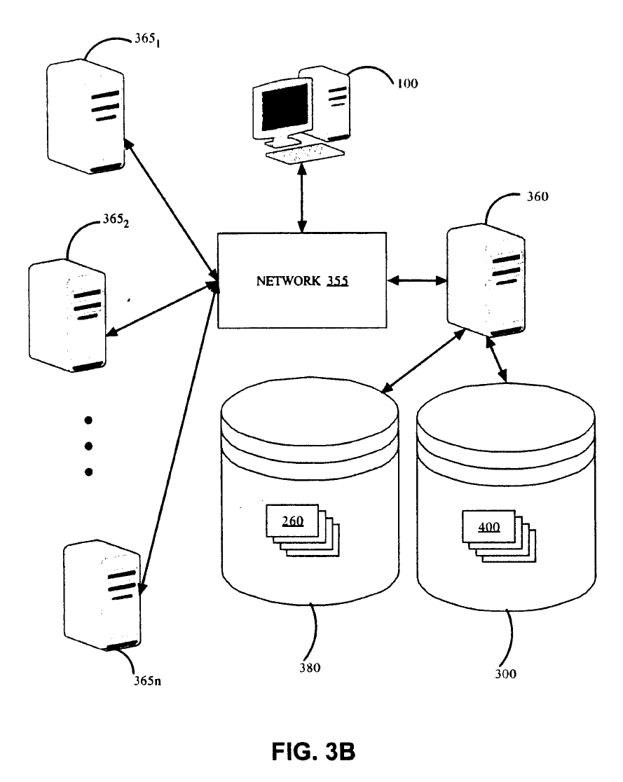

FIG. 3A illustrates a network configuration wherein the data processing system 100 is connected over a network 355, such as the internet, to a database 300 and a plurality of content servers 365₁ to 365_{N}.

A plurality of content servers 365₁ to 365_{N} are configured to act as web servers and provide data and media content, generally although not necessarily in the form of websites containing webpages, to the data processing system 100. The data processing system 100 can access any of the content servers 365 to view webpages contained on the content servers 365. The data processing system 100 uses the browser application 220 to access any of the content servers 365₁ to 365_{N}, which are web servers and the content accessed on any of the content servers 365 are generally files in a markup language which the browser application 220 displays as a website and webpages on the data processing system 100.

The database 300 contains metadata about a number of different websites and is operatively connected the data processing system 100 through the network 355. By using this stored metadata data, processing system 100 can automate a transaction sequence comprising a series of web pages on a website and in a further aspect automatically inserting the proper information to complete the transaction successfully.

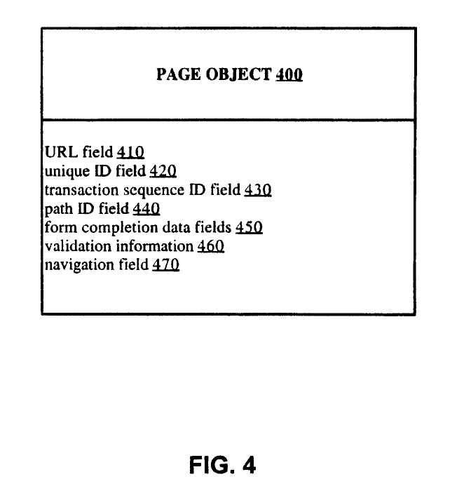

The database 300 contains a plurality of webpage objects 400, wherein each webpage object 400 corresponds to a particular web page on a website. FIG. 4 illustrates a data model of a webpage object 400 in accordance with one aspect. Each stored webpage object 400 contains information about field names and corresponding information types, form architecture, error conditions, and other useful information required to be able to successfully automate through a transaction sequence of webpages on a website. Each webpage in the transaction sequence defines an electronic form asking the user for some information required by the website to complete the transaction, i.e. customer name, shipping address, credit card information, etc. Once one of the electronic forms defined by a webpage has been successfully completed, the user can then move onto the next step (webpage) in the transaction series and provide the necessary information required to complete the electronic form defined by this next webpage. Once the transaction series has been completed by completing each electronic form defined by a webpage in the transactions series, the website will have enough information to complete the requested transaction (typically, purchasing a good and sending it to the buyer).

Each webpage object 400 contains metadata both about the webpage itself and the inputs of information requested on the webpage. Typically each webpage object 400 comprises: a base URL field 410; a transaction sequence identifier 420; a unique identifier 430; a path identifier 440; form completion data 450; optionally validation formatting information 460; and a navigation field 470.

The base URL field 410 contains a URL of the webpage a specific webpage object 400 corresponds to but typically stripped of all URL parameters (i.e. as per the HTTP spec). The URL field 410 is used as a first means of identifying the webpage that a specific webpage object 400 corresponds to.

Identifier data is provided in the form of the unique ID field 420, the transaction sequence ID field 430 and the path ID field 440 to be used as a means to verify that a particular webpage object 400 corresponds to a specific webpage that is currently being viewed as a step in a transaction sequence. The unique identifier field 420 stores a value that identifies what inputs are on the webpage, in order to provide an additional criteria with which the proper corresponding webpage can be verified. The value stored in the unique identifier field 420 is used as a way to differentiate webpages that share the same URL. In a DHTML environment, the contents of a webpage may be generated dynamically using the same URL. This means that although the URL might be the same, different inputs might be requested depending on what step of a transaction sequence a webpage is being displayed at. By using a unique identifier in addition to the URL of the webpage being viewed, webpages using the same URL, yet generated dynamically and asking for different inputs, can be differentiated.

In one aspect, the value stored in the unique ID field 420 is a hash value that is generated using the input names on the webpage being viewed. A hash value for the input names of the webpage being viewed is generated and this hash value is compared to a hash value stored in the unique ID field 420. By generating the hash value using the input names of the webpage, only another webpages with those same input names will result in the same hash value. If the hash value determined for a webpage being viewed does not match the hash value stored in the unique ID field 420, the webpage object 400 does not correspond with the webpage being viewed even though the URL may be the same.

In another aspect an array of hash codes could be stored in the unique ID field 430. A separate hash code could be generated for each requested input on the webpage with each separate hash code then stored in the array.

In another aspect, a keyword vector could be stored in the unique ID field 420. The keyword vector could be a vector where each dimension of the keyword vector corresponds to a keyword and the magnitude of the keyword vector in that dimension indicates the number of occurrences of the keyword on the webpage. To verify a webpage is the same webpage that corresponds to a webpage object 400, the keyword vector stored in the unique ID field 420 is compared to a keyword vector that is generated for a webpage to be examined. If the stored keyword vector matches the generated keyword vector, it is very likely the webpage is the same as the webpage corresponding to the webpage object 400.

The transaction sequence ID field 430 stores an identifier of the location of the webpage in a transaction sequence. Certain websites require that a user visit the same webpage in the website multiple times during a transaction sequence. For example, some websites use same-page postbacks, validation or simply a “state” webpage. Sometimes these webpages can not be differentiates using the unique identifier stored in the unique identifier field 420 of the page object 400 because the webpage may have the same input names, however, the user is required to insert different information or form submissions than the previous time and failure to differentiate those events will not result in a successful transaction. Alternatively, the input fields may be shown on the webpage with information previously provided with the user as a way of confirming the information and allowing the user to change the information if necessary, however, the webpage must be exited in a different manner than previously in order to carry on to the next webpage in the transaction sequence.

Optionally, a path ID field 440 holds a path identifier that can be used to determine one of three potential paths: new account; previous account logged in; and previous account not logged in. Often a user will have to navigate a series of webpages and enter certain information on these webpages based on whether they have an account with the website. This might involve the user having providing more information or less information depending on which of the paths the user must follow. For example, a new user that has never used a particular website may have to provide more information than a user that is logged in as a repeat user of a website. The value in the path identifier field 440 is used to determine whether the metadata is appropriate for a user.

Form completion data fields 450 provide information about the user-interactive form elements on the webpage and contains metadata both about the webpage itself and the inputs on the webpage and may contain a plurality of different entries. The form completion data fields 450 provide all of the instructions necessary for the interface application 250 to input the necessary information into the webpage to successfully provide the necessary inputs of the webpage corresponding to webpage object 400 in order to successfully complete the electronic form defined by the webpage. These input requested by the webpage could be for information to be inputted into fields on the webpage, selection of an item from a list (such as a drop down box), selection of a button, selection of a checkbox, etc. The form completion data fields 450 can provide a number of different types of information and instruction to enable the electronic form defined by the webpage to be successfully completed so that a user can navigate to a next webpage in the transaction series. The form completion data fields 450 can provide an indication of the mandatory inputs on the webpage that must be completed in order for the electronic form defined by the webpage to be successfully completed. Often, a webpage will request inputs that are not strictly required for the webpage to be successfully completed and the transaction will be successful even if certain inputs are not provided. The form completion data fields 450 can identify which inputs are mandatory and which are optional. Also, the form completion data fields 450 can provide mapping information that allows the interface application 250 to recognize what the information being requested by the webpage is and to match the requested information to information the interface application 250 has access to in the user record 260. For example, the information fields 450 may contain a mapping of the name of the user name called USER_FNAME by the webpage input tag to how it is identified in the user record 260, FIRST_NAME. This information tells the interface application 250 that the input being requested by the webpage USER_FNAME corresponds to FIRST_NAME (or how it is identified by the interface application 250). Additionally, this mapping might also include further information specifying how the input should be formatted in cases the webpage requires the input information to be stored in a different way from how it is stored in the user database. In some cases an input on the website might map to a field in the user record 260, however the user record 260 might provide the information in a different format than the input expects it. For example, an input on a webpage might map to a field in the user record 260 that contains a salutation identifier and the value stored in this field may be a string of “Mr”. However, the webpage requires an integer between 1 and 4 to represent the type of salutation that is appropriate, with the number 3 corresponding to “Mr”. The form completion data fields 450 would therefore identify the values that the string “Mr” corresponds to so that an acceptable value (in this case 3) for the input can be provided to the webpage.

This form completion data fields 450 also contain any information on formatting that is needed to properly enter the requested input. For example, the webpage may ask for a date to be inserted in three fields, one for day, month and year, however, the interface application 250 stores the date as an eight (8) digit number.

During a transaction, the interface application 250 may encounter an input which may be required for a transaction, but does not correspond to any information contained in user record 260 (for example an input prompting a user to adjust the quantity of items in their shopping cart). The form completion data fields 450 may contain information on how to handle such an input in order to complete the transaction. For example, the information field 450 may contain information for this input that the input should be populated by the interface application 250 with a default value, or ignored.

In this manner, the information fields 450 provide all the instructions and information necessary for the interface application 250 to provide all the requested inputs of the webpage corresponding to the page object 400, allowing the interface application 250 to successfully complete the form on the webpage.

Optionally, the webpage object 400 and/or information fields 450 may contain validation formatting information 470 that allows the input submitted to the webpage to be validated or formatted correctly before the webpage is submitted.

Finally, the webpage object 400 comprises a navigation field 470 that indicates the next action that has to be carried out in order to navigate to the next webpage in the transaction sequence. This navigation field 470 typically comprises at least one of: the next page URI/URL; or what is necessary to submit the form on the current webpage. For example, the name of the input that causes the form submission and subsequent navigation to the next page, and what kind of event triggers the form submission (user click, key press, etc.) The interface application 250 uses the navigation field 470 to determine how to move to the next webpage in the transaction sequence after it has provided all the inputs necessary to successfully complete the form on the current webpage.

Using the Webpage Objects to Navigate a Transaction Sequence

By using the webpage objects 400 stored in the database 300 the automation of a transaction sequence consisting of a series of webpages on a website can be automatically navigated by the interface application 250. The interface application 250 can provide a generic interface for a user or other program to any number of different websites. Instead of merely providing a means to automatically complete forms on a single webpage, the interface application 250 is able to automatically navigate a series of webpages in a transaction sequence once an electronic form defined by a website has been successfully completed without a user having manually intervene in order to navigate to the next webpage in the transaction series.

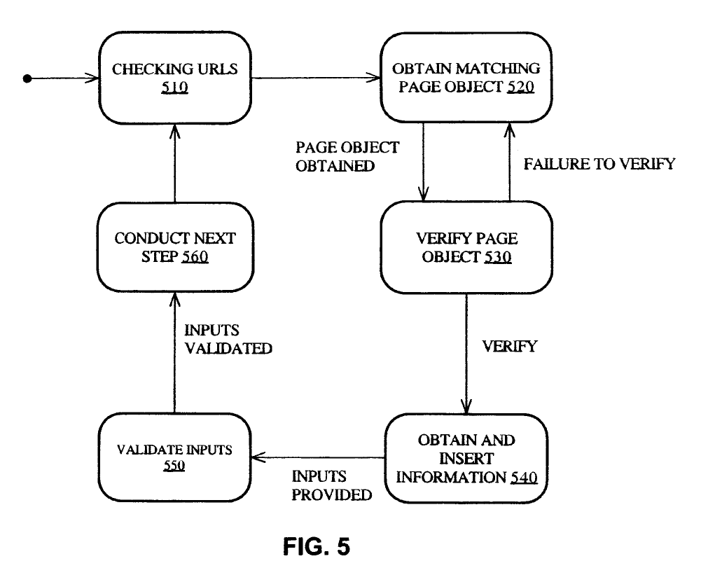

FIG. 5 illustrates a state diagram 500 of the interface application 250 as it navigates through a transaction sequence. As a user navigates through webpages on the content servers 365, interface application 250 is in state 510 and is intercepting the URL of each webpage viewed by the browser application 210. The interface application 250 uses the intercepted URLs to try and match the intercepted URL to a page object 400 stored in the database 300.

Referring to FIG. 4, the interface application 250 could match the base URL of a page being viewed directly to the URL field 410 of a webpage object 400 or the interface could download a file periodically from the database 300 that can be stored on a data processing system 100 that identifies webpage objects 400 in the database 300 without requiring the data processing system 100 to communicate with the database 300 each time the user views a webpage using the data processing 100.

Referring again to FIG. 5, the interface application 250 continues to intercept the URL of the webpages being viewed by the web browser 210 and when the interface application 250 finds a URL that matches a webpage object 400 in the database 300, the interface application 250 enters state 520. In state 520, the interface application 250 communicates with database 300 and obtains the webpage object 400 having a URL in the URL field 410 that matches the current webpage being viewed.

Once the interface application 250 obtains the webpage object 400, the interface application 250 enters state 530 where it checks the webpage object 400 against the webpage being viewed to verify whether or not the webpage object 400 truly reflects the webpage that is currently being viewed. This process involves a number of checks. The unique identifier in the unique ID field 420 of the page object 400 is checked against the webpage being viewed to verify that the webpage being viewed is the webpage represented by the page object 400. In one aspect a hash of the input names on the webpage is made and compared to the hash value stored in the unique identifier field 420 of the page object 400. In another aspect, a keyword vector is generated for the webpage and compared against a keyword vector stored in the unique identifier field 420. The transaction sequence ID in the transaction sequence ID field 430 is also checked to verify the webpage being viewed matches the webpage represented by the webpage object 400. If the path ID field 430 is used, the path ID stored in the path ID field 430 is also checked to make sure the information 450 in the webpage object 400 is for the proper path the interface application 250 is following.

If the interface application 250 cannot verify the webpage object 400 against the webpage being viewed at state 530, the interface application 250 moves back into state 520 and tries to obtain another webpage object 400 with a URL contained in the URL field 410 matching the base URL of the webpage being viewed. When the interface application 250 finds another webpage object 400 that contains the same base URL in the URL field 410 of the webpage object 400, the interface application 250 will once again move into state 520 and once again attempt to verify the newly found webpage object 400 against the webpage being viewed.

Once the interface application 250 finds a webpage object 400 that it can verify matches the webpage being viewed, the interface application 250 enters state 540 where it inserts that information required for the webpage, as instructed by the information fields 450 in the webpage object 400. For example, the interface application 250 will map the inputs requested by the webpage, using the form completion data fields 450, to the information the interface application 250 is aware of in the user record 260 to allow the interface application 250 to submit the requested inputs to the webpage and successfully complete the electronic form defined by the webpage.

Once the inputs have been provided to the webpage as specified by the information contained in the form completion data fields 450 of the webpage object 400, application interface 250 enters state 550 if a validation form completion data field 460 is provided. In state 550, the application interface 250 uses the information in this field to validate the information provided to the inputs before moving on to state 560.

Once the interface application 250 has provided the necessary requested inputs to the current webpage by using the instructions provided in the form completion data fields 450 of the webpage object 400 to provide the proper inputs requested or required by the webpage, the interface application 250 moves into state 560 and the navigation field 460 of the webpage object 400 is used by the interface application 250 to navigate to the next webpage in the transaction sequence of the website.

At this point the interface application 250 is again in original state 510 and simply intercepts the URL of the webpage being viewed and again attempts to match it to a webpage object 400 in the database 300. The interface application 250 does not need to have pre-existing knowledge of all the steps in the transaction sequence, it merely matches each webpage to a webpage object 400 as it encounters each webpage in the transaction sequence; follows the instructions in the information fields 450 to provide the requested input for the webpage to successfully complete the electronic form defined by the webpage; and then navigates to the next webpage, using the navigation field 470 to instruct it how to navigate to the next step (webpage) in the transaction sequence. Because the previous webpage was identified as a step in a transaction sequence and the present webpage being viewed was arrived at by following the instructions in the navigation field 460 of the webpage object 400 corresponding with the previous webpage that was viewed, the next webpage is almost certainly the next step in a transaction sequence. The interface application 250 does not need to have comprehensive knowledge of the previous webpage, it simply continues to intercepts the URL of the webpages being viewed by the web browser application 210 and matching them to their corresponding webpage object 400 in that database 300. In this manner, the interface application 250 can navigate a series of webpages in a transaction sequence one by one providing the requested or necessary inputs and completing the electronic form defined by each webpage and moving to the next web page in the transaction sequence until the entire transaction sequence has been completed.

The interface application 250 can be used to completely automate the completion of a transaction sequence for a website, providing all of the information as needed as it is requested on a webpage by the website. However, the interface application 250 can also serve as a uniform interface between a user or another program application to allow a user or the other program application to provide uniform inputs to the interface application 250 which are then used to conduct a transaction sequence on a number of different websites, irregardless of the format and order the website is requesting the information.

In one aspect a uniform user interface is provided by the interface application 250 and displayed to a user so that, although the user is requested to provide information, the user interface is the same for any number of different websites the user is accessing. In this manner, a user can always see a familiar user interface rather than having to figure out a different transaction sequence for each new website he or she visits.

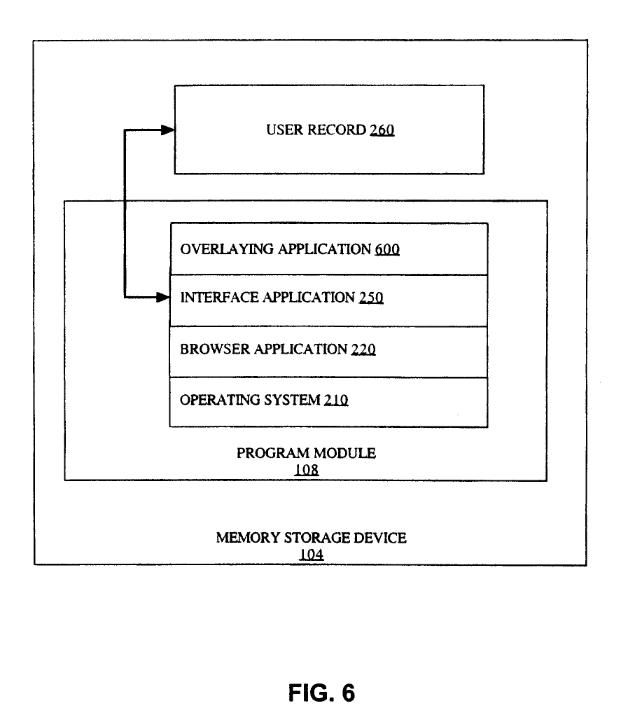

In another aspect, the interface application 250 allows another program application to interact with the website. FIG. 6 illustrates a schematic illustration of a program module 108 in a memory storage device 104 of the data processing system 100 wherein the application interface 250 is acting as a generic interface to the browser application 220 for an overlaying application 600. Overlaying application 600 must interact with a transaction sequence on a number of website, but rather than requiring any specifics knowledge of the various websites, the overlaying application 600 has uniform inputs and outputs to the interface application 250 that allows the interface application 250 to navigate transaction sequences on a number of different websites.

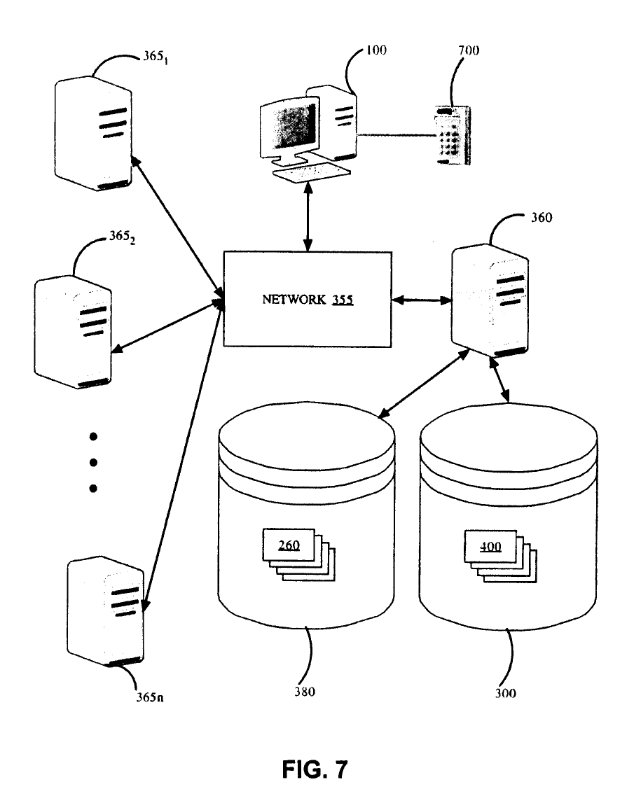

FIG. 7 illustrates an aspect of the overlaying application 600 where it communicates with a card reader 700 that is operably connected to the data processing system 100 running the overlaying application 600. When a webpage object 400 is obtained by the interface application 250 wherein the form completion data field 450 informs the interface application 250 that at least some of the inputs on the webpage require input available from a card such as payment information available from a credit card or other banking card, the interface application 250 communicates with the overlaying application 600. The overlaying application 600 in turn communicates with the card reader 700 and prompts the user to swipe his or her card in the card reader 700. The overlaying application 700 receives the information from the card (either unencrypted or encrypted) from the card reader 700 that was generated from the user swiping his or her credit card in the card reader 700. This information is then passed to the interface application 250 to be submitted to the website in the proper input field.

Typically, the card is a credit card, debit card or other banking card. However, it could be another form of readable identification card, such as a driver's license, retailer's loyalty card, etc. In one aspect, the card reader is operative to read cards conforming to the ISO 7810 standard.

Without the interface application 250 operating using the above disclosed methods, the overlaying application 600 would have no idea when the card reader 600 should be used, nor how the information from the card reader 600 should be used.

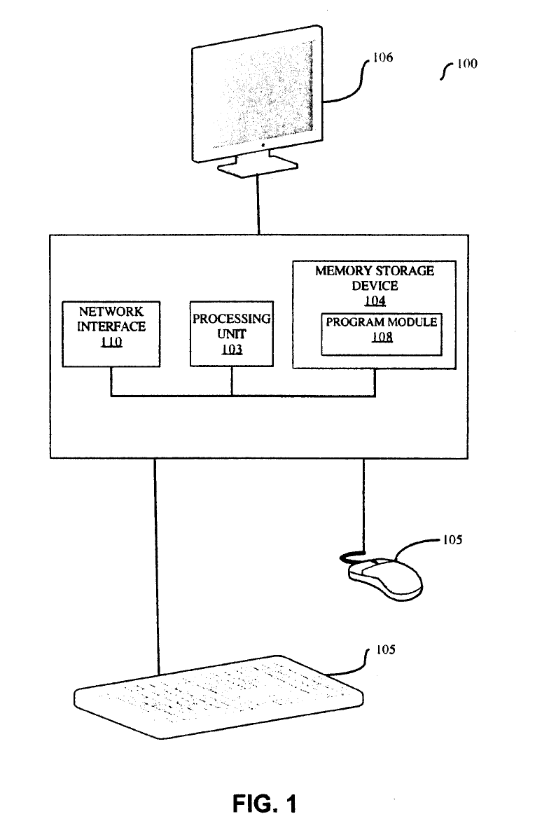

Referring again to FIGS. 1, 2 and 3A, the user record 260 is illustrated stored in the memory storage device 104 of the data processing system 100. This allows the data processing system 100 to obtain user information from the locally stored user record 260. Alternatively, FIG. 3B illustrates a schematic illustration of another aspect of a network configuration containing central user database 380. Central user database 380 contains a plurality of user records 260 with each stored user record 260 corresponding to specific user. In this manner, data processing system 100 does not need to maintain a copy of a user's sensitive personal information, but rather all the personal information is stored on the central user database 380. This allows a user to access a random data processing system 100, yet still allow the use of the methods disclosed herein.

In one aspect, data processing system 100 could be a specialized computer/kiosk system that would allow a number of different users to use the data processing system 100 for the methods disclosed within by accessing their unique user record 260 stored on the central user database 380 with the data processing system 100. The data processing system 100 could be configured as a one-piece integrated device with the display device 106 being a screen integrated into the data processing system 100 and the input device 105 being an integrated keyboard or even combined with the display device 106 by providing a touchscreen display for the display device 106.

The data processing system 100 could be configured to provide only limited features. In one aspect, the data processing system 100 could run only a minimal operating system with a web browser that is limited to only accessing webpages belonging to a person, such as a retailer, providing the data processing system 100. By limiting the web browsers access, a general user operating the specially configured data processing system 100 could only access webpages and therefore transactions series which only allow the general user to purchase products from the person operating the specialized data processing system 100.

In this manner, a retailer could provide a specially configured data processing system 100 at a location such as a tradeshow or other in a retail store that allows general users to use the methods disclosed herein to purchase products from the retailer that may or may not be present at the location. A general user could use the data processing system 100 to access only webpages belonging to the retailer without the user being able to access any other websites.

Database Population

The webpage objects 400 in the database 300 can be populated in a number of ways. The easiest method to implement is to have a person manually go through the website and enter the correct information needed for each webpage object 400. This could be done by a person manually editing the database 300, but in a further aspect involves a specially designed user interface that a user will look at while they navigate a website and enter in the information as they go along. When a user navigates to a webpage that does not have a corresponding webpage object 400 in the database 300, the user will be presented with an interface and the user will classify: which inputs are required for a successful completion of the webpage; the appropriate values to go into the inputs or the class of information that should go into the inputs; any special formatting required for a given input; the path they are using (e.g. new user, etc.); and the method of navigating to the next step (i.e. typically form submission).

With this information, a webpage object 400 for the web page can be created and stored in the database 300.

Passive Transaction Monitoring

The database can also be populated by passively monitoring a user as he or she manually navigates a series of webpages on a website to complete a transaction series. By passively monitoring and examining the interaction of a user with a specific website, the necessary information need to create the corresponding webpage objects 400 can be obtained.

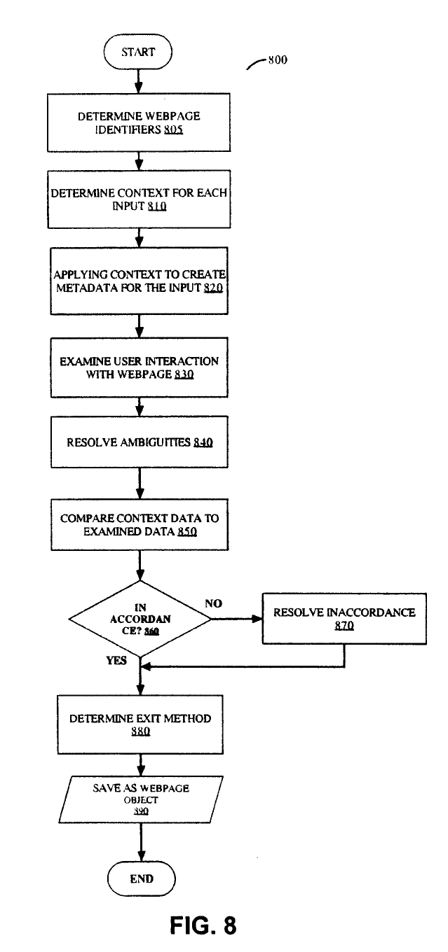

FIG. 8 illustrates a flowchart of method 800 for creating a webpage object 400 by passively monitoring a user as he or she completes a webpage that is a step in a transaction series on a website. The method 800 is typically implemented by the interface application 250 running on the data processing device 100 operated by the user and comprises the steps of: determining webpage identifiers 805; determining a context for each input 810; applying the determined context to create metadata for the input 820; examining user interaction with webpages 830; resolving ambiguities 840; comparing context data to examined data 850; checking to see if the context data and examined data are in accordance 860; resolving the inaccordance 870; determining an exit method 880 and saving the metadata as a webpage object 890.

Method 800 begins when a user navigates to a webpage on a website that is part of a transaction series. At step 805, the method 800 determines a set of webpage identifiers for the webpage currently being viewed by the user. These webpage identifiers will include the URL, the unique identifier, transaction sequence identifier and optionally the path identifier, which will be stored in the URL field 410, unique ID field 420, transaction sequence ID field 430, and optionally the path ID field 440 of the eventual page object 400 created for the webpage, respectively.

At step 810, the method 800 determines the context for each requested input on the webpage. This context could include the unique identifiers that the webpage uses to tag the input, the label text for the input field, the adjacent text, location of the input field relative to other elements on the pages, etc.

At step 820, the context for each input on the webpage is used to create metadata about the input. By analyzing the metadata created from the determined context, information about they requested inputs can be determined. For example, certain information requests are typically grouped with other information, such as last name and first name in the same area and street address is typically followed by the city that the user lives in. This metadata is used to determine a number of characteristics about the inputs such as: what class of information the field should contain (labeled as an address, etc.); if any value needs to be inserted into the input to successfully execute a transaction (whether the context marks it as a required input); if the value is unique to the transaction or consistent across all transactions; any formatting required by the input field (e.g. a phone number) or if the field contains multipart data (i.e. a phone number with an area code).

At step 830, the method 800 then examines how the user interacts with the webpage. Each input that is entered or modified by the user is recorded and this user input is used to create a mapping between an element the user interacted with and the type of information required by that input. The interface application 250 will examine the information input by the user into an element in the webpage and try to match it to information available about the user in the user record 260.

The interface application 250 with its access to the user record 260 containing user information is used to map the input fields in step 830. This user information will be information about a user that is commonly requested by a website and typically comprises a first name of the user, a shipping address, card number, etc., however, there could be a multitude of information in the user database 360, e.g. there may be more than one shipping address, etc. Each field containing information in the user record 260 will have a textual identifier for the file (i.e. FIRST_NAME to identify a field that will contain the first name of a user).

If the interface application 250 is able to match the input information to a value stored in the user record 260 about the user, the interface application 250 can map the input to the field in the user record 260 and associate the textual identifier for the field in the user record 260 to the input field on the webpage. For example, if the interface application 250 examines the input of a user to a field on the webpage and determines that it matches the information contained in a field called FIRST_NAME in the user record 260, the interface application 250 can associate the input field as asking for the first name of a user, which is stored in the user record 260 corresponding to the user under FIRST_NAME.

Next, method 800 tries to resolve any ambiguities in the information input to the webpage by the user at step 840. For example, for a date such as Oct. 10, 1982, a user might enter a “10” into a single input field on the webpage. This could refer to either the day of the month. In order to resolve this ambiguity, the application interface 250 can either: use the context to see if it can determine what the information being input is (i.e. the label text could include the text string “MONTH” and the interface application 250 would then know that the 10 input by the user refers to the month portion of the date); or prompt the user to manually resolve the ambiguities (i.e. prompt them to identify from a list what the input is related to).

At step 850, the method 800 verifies the classification it has given the input fields on the webpage being viewed by examining the input of the user against the context it has determined for the input field. The method 800 compares the context it has determined for each input on the webpage at step 820 to the information entered by the user and examined in step 830. For example, the application interface 250 may have determined from the context that a set of input fields relates to a shipping address and therefore certain types of information are expected to be mapped to a filed, such as street address, city, country, etc. Therefore, if the method 800 has classified one of these input fields as something other than information related to a shipping address, this classification will not be verified at step 850.

If the context agrees with how the information was classified by the interface application 250, the method 800 moves on to step 880. However, if the context does not agree with how the interface application 250 has classified the information, the method 800 will determine whether to accept the manually inserted information, the calculated context or require additional training data to classify the field, at step 870.

At step 880, the exit method for submitting the information requested by the webpage and moving to the next webpage in the transaction sequence is recorded. The interface application 250 record the action a user performs to initiate navigation from the current webpage to the next webpage in the transaction sequence, whether this action is a direct action or indirect action.

Finally, at step 890, the metadata from the above process is used to create a page object 400 corresponding to the webpage and this page object 400 is saved to the database 300.

The created page object 400 may be proofed and tested at a later time.

Automatic Population of the Database Via an Intelligent Agent

In a further aspect, the database 300 can be populated with webpage objects 400 using an intelligent agent that navigates through a website and extracts metadata from the webpage in the website to create webpage objects 400 corresponding to a series of webpages making up a transaction series. The intelligent agent does not have to operate in conjunction with a web browser or wait for a user to access and navigate through a website, rather the intelligent agent works autonomously from a user and can crawl through websites without user intervention.

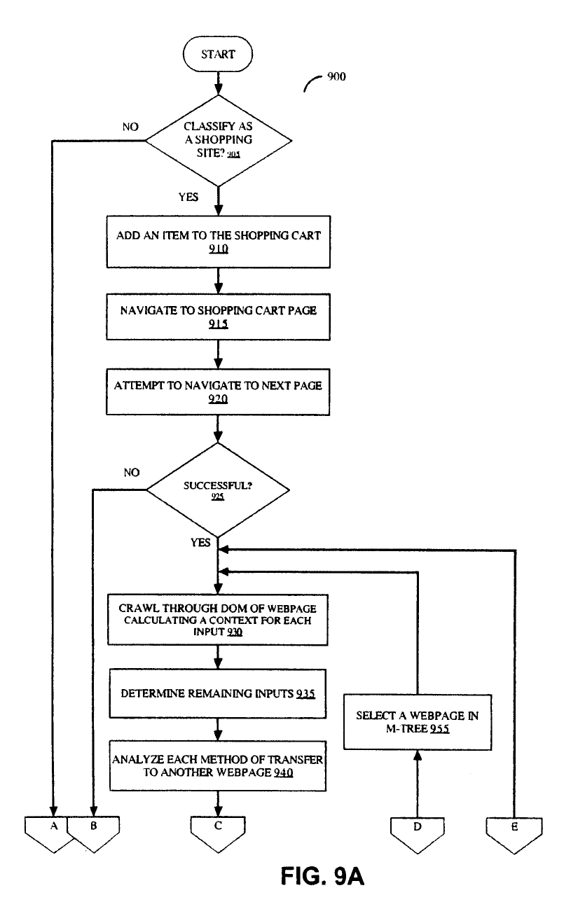

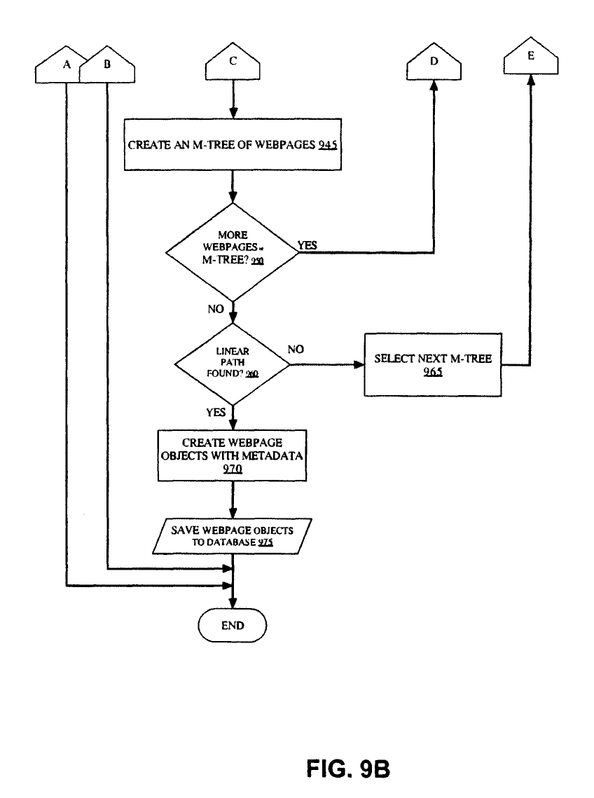

FIG. 9 illustrates a flowchart of method 900 used by an intelligent agent for automatically populating the database 300 with page objects 400. Method 900 comprises the steps of: determining whether a website is a shopping website 905; adding an item to the shopping cart 910; navigating to a shopping cart page on the website 915; attempting to navigate to a next page in the transaction sequence 920; checking if it was successful 925; crawling through the DOM of the web page and calculating context for each input 930; determining remaining inputs 935; analyzing each method of transferring to another web page 940; creating an M-tree of web pages 945; checking more web pages occur in the M-tree 950; selecting a web page in the M-tree 955; checking if a linear path through the transaction sequence has been located 960; selecting a next M-tree 965; creating a webpage objects with the collected metadata 970; and saving the webpage objects to a database 975.

The method 900 begins by navigating to the home page of a website. At step 905, the method 900 attempts to determine whether the website is a shopping website. If the website is not a shopping website, the method 900 ends.

If the method 900 at step 905 determines that website is a shopping website, the method 900 proceeds to step 910 where it attempts to add an item to the shopping cart and then navigates to the shopping cart page at step 915. From step 915, the method 900 attempts to automatically navigate through the transaction sequence in order to create a webpage object 400 for each webpage in the transaction sequence. An item is attempted to be purchased so that the method 900 can try to determine how to complete a successful transaction sequence for the website.

From the shopping chart page, the method 900 attempts to navigate to the next webpage in the transaction sequence at step 920. This will typically be either a checkout webpage or a login/registration page. From step 920, the method 900 will being recording information related to the transaction sequence to attempt to generate the necessary webpage objects 400. If the method 900 fails to navigate to the first page in a transaction sequence at step 925, the method 900 ends.

However, if at step 925 the method 900 is successful at navigating to the first webpage in the transaction sequence, the method 900 moves to step 930 and crawls through the DOM of the current web page. The document object model (or DOM) of the current webpage calculating the context each requested input on the webpage and using the context to determine what the information that is necessary to input to the webpage in order to successfully complete the current webpage. In this manner, step 930 determines which inputs are requested by the current webpage.

At step 935, the method 900 examines the context determined at step 930 and determines which inputs remain out of the set of basic inputs required for a successful completion of the transaction series, e.g. shipping address, billing address, billing information etc. In this way the method 900 can keep track of the information the transaction input has already requested so that it can be taken into account when using the context of later webpages to determine what information later pages may requests as input. For example, if the billing address is already requested on the first webpage in the transaction series, the method 900 may determine from the context of a webpage that an address is being requested, however since the billing address was already requested in an earlier webpage in the transaction sequence, the method 900 can use it to decide the address being asked for is the shipping address.

At step 940, the method 900 analyzes each method of transfer to another webpage and at step 945 creates an M-tree of webpages that can be visited from the current webpage. Each webpage that can be navigated to from the current webpage is represented in the M-tree.

Steps 950 and 955 cause each webpage in the M-tree to be navigated to by the method 900 with steps 930, 935, 940 and 945 repeated for each webpage in the M-tree.

Once all the webpages in the M-tree created for the first page has been examined by the method 900, the method 900 checks at step 960 to see if a linear path has been found through the transaction series. The M-tree of the next webpage is selected and steps 930, 935, 940, 945, 950 and 955 are repeated for the M-tree created from the next webpage.

In this manner, the method 900 crawls through the webpages moving from webpage to webpage until a path is found at step 960 that allows a successful transaction. This path is then used as the transaction series.

The information gathered in the method 900 related to the webpages is then used to create page objects 400 for each web page identified in the transaction series and saved to the database 300 at step 975.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A method of navigating a transaction series comprising a plurality of webpages, the method comprising:
providing a plurality of webpage objects, each webpage object corresponding to a webpage, the webpage defining an electronic form having at least one input, each webpage object having:
form completion data providing instructions to successfully complete the electronic form defined by the corresponding webpage by providing proper input to the at least one input; and
navigation action data indicating an action to be taken to navigate to a next webpage in the transaction series,
checking a webpage against the plurality of webpage objects;
if the accessed webpage corresponds to one of the webpage objects, then using the instructions in the webpage object to complete the electronic form defined by the webpage by providing the at least one input, and in response to the electronic form being completed, invoking the action indicated by the navigation action data to navigate to the next webpage in the transaction sequence.

2. The method of claim 1 further comprising verifying the accessed webpage corresponds to one of the webpage objects by using identifier data stored in the webpage object.

3. The method of claim 2 wherein the identifier data is at least one hash value generated from the webpage.

4. The method of claim 2 wherein the identifier data is a keyword vector generated from the webpage.

5. The method of claim 1 further comprising verifying the webpage is a next webpage in the transaction series.

6. The method of claim 1 further comprising providing a user record having at least one piece of data relating to a user, and wherein the form completion data indicates a correspondence between one of the at least one inputs of the referenced webpage and one of the at least one piece of data relating to a user in the user record.

7. The method of claim 6 wherein the user record contains at least one of the following: a user name, a shipping address and preferences.

8. The method of claim 6 wherein the electronic form is completed by matching each at least one input on the accessed webpage to the one of the at least one piece of data in the user record and automatically providing the corresponding one of the at least one piece of data to the webpage.

9. The method of claim 6 further comprising provided an interface having input fields and wherein the form content data provides instructions to correlate the input fields of the interface to the at lest one input of the webpage.

10. The method of claim 1 wherein when the form completion data indicates that one of the at least one input of the referenced webpage requires credit card information, notifying a user to swipe a credit card in a card reader and obtaining the credit card information from the peripheral card reader.

11. A computer readable memory having recorded thereon statements and instructions for execution by a data processing system to carry out the method of claim 1.

12. A memory for storing data for access by an application program being executed on a data processing system, comprising:
a data structure stored in said memory, said data structure including information resident in a database used by said application program to enable said application to navigate and complete a transaction series comprising a plurality of webpages, the data structure including:
a plurality of webpage objects, each webpage object referencing a webpage defining an electronic form having at least one input, each webpage object containing:
identifier data identifying the referenced webpage, the webpage being one of the plurality of webpages in the transaction series;
form completion data providing the application program with instructions enabling the application program to provide a proper input to the at least one input and successfully complete the electronic form defined by the webpage; and
navigation action data indicating an action to be taken by the application program that will cause the application program to navigate to a next webpage in the transaction series.

13. The memory of claim 12 wherein the identifier data contains a URL address of the referenced webpage.

14. The memory of claim 13 wherein the identifier data contains at least one hash value generated from the referenced webpage.

15. The memory of claim 13 wherein the identifier data contains a keyword vector generated from the referenced webpage.

16. The memory of claim 13 wherein the identifier data contains a transaction sequence identifier, indicating what step in the transaction series the referenced webpage is.

17. The memory of claim 13 wherein the identifier data is a path identifier, indicating one of the following: the transaction series is for a new account; previous account logged in; and previous account not logged in.

18. The memory of claim 12 wherein at least one webpage object further comprises identifier data providing at least two ways of verifying a webpage corresponds to the webpage referenced by the webpage object.

19. The memory of claim 12 wherein the navigation action data comprises an address of the next webpage in the transaction series.

20. The memory of claim 19 wherein the address of the next webpage in the transaction series is a URL address.

21. The memory of claim 12 wherein the navigation action data comprise an indication of one of the inputs on the webpage wherein selection of the indicated input results in a navigation to the next webpage in the transaction series.

22. The memory of claim 12 wherein the form completion data includes instructions enabling the application program to correlate the at least one input on the referenced webpage with user data accessible by the application program and containing personal information specific to a user.

23. The memory of claim 12 wherein the form completion data includes an indication of any of the at least one input that is necessary to complete the form defined by the webpage.

24. A data processing system for navigating a transaction series comprising a plurality of webpages, the data processing system comprising:
at least one processor;
a memory operatively coupled to the at least one processor;
a display device operative to display data;
a network interface operably connecting the data processing system to the internet; and
a program module stored in the memory and operative for providing instructions to the at least one processor, the at least one processor responsive to the instructions of the program module, the program module operative for:
accessing a webpage;
accessing a database containing a plurality of webpage objects, each webpage object corresponding to a webpage, the webpage defining an electronic form having at least one input, each webpage object having:
form completion data providing instructions to enable the data processing system to successfully complete the electronic form defined by the corresponding webpage by instructing the data processing system how to provide proper input for the at least one input; and
navigation action data indicating an action to be taken to navigate to a next webpage in the transaction series,
checking the accessed webpage against the plurality of webpage objects;
if the accessed webpage corresponds to one of the webpage objects, then using the instructions in the webpage object to complete the electronic form defined by the webpage by providing the at least one input, and in response to the electronic form being completed, invoking the action indicated by the navigation action data to navigate to the next webpage in the transaction sequence.

25. The data processing system of claim 24 wherein the program modules is further operative for verifying the accessed webpage corresponds to one of the webpage objects by using identifier data stored in the webpage object.

26. The data processing system of claim 24 wherein the program module is further operative for accessing a user record having at least one piece of data relating to a user, and wherein the form completion data indicates a correspondence between one of the at least one inputs of the referenced webpage and one of the at least one piece of data relating to a user in the user record.

27. The data processing system of claim 26 wherein the user record contains at least one of the following: a user name, a shipping address and preferences.

28. The data processing system of claim 26 wherein the program module is further operative for matching each at least one input of the electronic form on the accessed webpage to the one of the at least one piece of data in the user record and automatically providing the corresponding one of the at least one piece of data to the webpage.

29. The data processing system of claim 26 wherein the program module is further operative for providing an interface having input fields and wherein the form content data provides instructions to correlate the input fields of the interface to the at lest one input of the webpage.

30. A system for navigating a transaction series comprising a plurality of webpages, the system comprising:
a card reader operative to read data from a card; and
a data processing system, operatively coupled to the card reader and operative to receive data from the card reader, the data processing system having:
at least one processing unit;
a display device operative to display data;
at least one memory storage device operatively coupled to the processing unit;
a network interface operative to connect the data processing system to the internet; and
a program module stored in the at least one memory storage device operative for providing instructions to the at least one processing unit, the at least one processing unit responsive to the instructions of the program module, the program module operative for:
accessing a webpage;
accessing a database containing a plurality of webpage objects, each webpage object corresponding to a webpage, the webpage defining an electronic form having at least one input, each webpage object having:
form completion data providing instructions to enable the data processing unit to successfully complete the electronic form defined by the corresponding webpage by instructing the data process system how to provide proper input for the at least one input; and
navigation action data indicating an action to be taken to navigate to a next webpage in the transaction series,
checking the accessed webpage against the plurality of webpage objects;
if the accessed webpage corresponds to one of the webpage objects, then using the instructions in the webpage object to complete the electronic form defined by the webpage by providing the at least one input, if the instructions include an indication that one of the at least one input of the accessed webpage requires payment information available on identification cards, notifying a user to swipe an identification card in the card reader, obtaining the payment information from the card reader and providing the payment information for the corresponding inputs; and
in response to the electronic form being completed, invoking the action indicated by the navigation action data to navigate to the next webpage in the transaction sequence,
wherein the card reader is operative for:
reading information from an identification card and passing the read information to the data processing system.

31. The system of claim 30 wherein the card reader is peripheral from the data processing system.

32. The system of claim 30 wherein the identification card conforms to the ISO 7810 standard.

33. The system of claim 30 wherein the identification card is a banking card.

34. The system of claim 33 wherein the identification card is a credit card.

35. The system of claim 33 wherein the identification card is a debit card.
